(19) United States
(12) Patent Application Publication
(10) Pub. No.: US 2006/0053492 A1
(43) Pub. Date: Mar. 9, 2006

(54) Software tracking protection system

(76) Inventor: David Robert Wallace, San Francisco, CA (US)

Correspondence Address: David R. Wallace, 1960 Jones St., San Francisco, CA, 94133, US

(21) Appl. No.: 11/220,288

(22) Filed: Sep. 6, 2005

Related U.S. Application Data
(60) Provisional application No. 60/607,763, filed on Sep. 7, 2004.

(51) Int. Cl. H04N 7/16

(52) U.S. Cl. 726/26

(57) ABSTRACT

The invention protects software on a data processor by first identifying the software, authenticating it, and then tracking it down to the memory of the processor where it executes. The invention then protects the software in the memory during execution. The invention creates a chain of protection from the origin of the software through to its use at the lowest levels of the hardware.

Priority of provisional application No. 0/607763, filed Sep. 7, 2004, is hereby claimed.

### FIELD OF THE INVENTION

This invention relates to the field of computer system security, specifically relating to both attacks on existing software or the introduction of unauthorized software.

### BACKGROUND OF THE INVENTION

Computer system attacks arise from agents such as viruses, worms, spyware, Trojans and root kits. There are two basic forms of protection available now: blacklist and behavioral monitoring.

Blacklist Approaches

This involves identifying known attacks. Protection includes anti-virus and anti-spyware systems, which look for binary or character string patterns to recognize the known attacks.

Behavioral Monitoring Approaches

This involves statistical analysis of program behavior, usually through examining patterns of system calls. Good behavior patterns are identified during a learning period and are saved in a database. After sufficient learning, behavior patterns that do not match a stored pattern are identified as bad, leading to alerts or even blocking the execution of the software exhibiting the bad behavior.

Typical examples of this protection method include IDS, intrusion detection systems, or IPS, intrusion preventions systems.

Protection Failures

Any new attack will be completely missed by a blacklist approach because the pattern for the new attack has not yet been distributed to the pattern matching agents.

There are two basic problems with behavioral approaches. One is termed “false positives”, where new, but legitimate behavior is identified as bad. False positives tend to be a problem in highly dynamic environments, such as that found in many large enterprises.

The other is bad software that fits into the good behavior patterns. The largest current example of this is spyware and adware, which appear normal and so are not detected but are undesired and potentially hazardous.

Attacks

Programs on disk rarely have any associated integrity checking. Consequently it is straightforward for an attacker to modify an application program or player on disk to open up runtime access to its internal operations and its internal unencrypted data. This is a mode of attack common to Trojans and viruses.

Spyware and adware typically inject a foreign DLL into a running OS process. That DLL then hijacks a normal system call from the application in the OS process under attack, taking control away from the normal code.

Security Issues

It is now common to have applications corrupted or hijacked by viruses or to have spyware or Trojans run that gather passwords or other critical data and send them outside of supposedly protected or secure computing environment.

Even hardware-enhanced security systems can be compromised in some situations through unexpected inputs from outside agents, in some cases allowing such agents to view decrypted data in the clear. For example, an unexpected flaw in application code can lead to a buffer overflow attack where foreign code is introduced through normal user input. Such foreign code then executes at the same permission level as the original application code and can easily access decrypted data in memory.

In a typical Enterprise application with a database, that database ultimately stores all of its data on disk. Files on disk have some protection, such as access control lists, but in most cases such access controls are not properly set up or are easily compromised by insiders. Since databases are rarely encrypted, critical data can be easily obtained by attackers, especially insiders.

A difficulty with encryption schemes for protecting either digital content or Enterprise data in information systems is that encrypted content or data generally is decrypted “in the open”, e.g. within the memory of an executing OS process. In most systems, this OS process is not fully or not at all secure and can be compromised, thereby allowing an unauthorized other OS process, user or attacker to view data as it sits unencrypted in working or paged memory of an information processing system. As a result, many current schemes to protect software, audio or video have been compromised.

### SUMMARY OF THE INVENTION

By far, most attacks that compromise a PC desktop or server rely on introducing foreign code in some way, either as an added component or as a modification to an existing component. This invention stops such attacks by insuring that only known authenticated code is run. Further, this invention protects such authenticated software all the way down to the memory where it is executed.

The first step in such a process is to identify and authenticate both system and application code at a level of detail that allows the authenticated code to be protected and, in addition, allows it to be differentiated from code that is not authenticated. The second step is to actually accomplish that protection and differentiation.

It is fairly straightforward to discover and identify the software installed on a particular machine. Applications are usually listed in the Registry. Most applications are started from an “exe” suffix file and continues to use various “dll” suffixed files called dynamic link libraries. Each such file has an internal list of the DLLs that it uses, allowing the generation of a complete parts list of DLLs for each application by means of the recursive processing of theses lists.

Authentication of that discovered software is more complex, falling into three basic categories. First, known commercial software is the easiest to authenticate since it is easy to validate its content, either by direct means of via hash signatures, including, e.g. MD5 or SHA-1.

The second category is privately developed software. Such software will be well known by the staff at the entity or enterprise that own the computer to be protected. Private software will most likely have been developed by this entity itself or under private contract with another party.

The final category is the remaining unknown software. Generally, this category is quite small once the first two categories are taken care of. Consequently, unknown software is amenable to both further investigation as to its origin and also to continued surveillance to discover its true function.

The most logical place for software authentication information would be a database, which could be either distributed or centralized. At an enterprise a central server system can gather information about various software discovered within its network and coordinate the authentication functions for this software as the software system evolve through updates patches and other changes

The various discovery and authentication functions needed for protection can be either distributed or centralized in whole or in part without modifying their basic operational structure. The above description is not meant to limit the type of distributed or centralized structure of this invention. For the following discussion and description, the term administrator or admin can refer to an agent of a particular entity or enterprise that controls the computer or computers to be protected or of one or more separate entities that provide all of some of the authentication functions as a service.

Protection and Differentiation

Once the software on a machine is discovered and authenticated, the System tracks that software's use by the computer at the hardware level, specifically through the steps of loading or mapping from disk into memory and then the execution of the software in the memory by the processor unit, as tracked by the virtual memory system and the related TLB (translation lookaside buffer) address translation mapping caches. This low-level tracking of software at the memory page level allows both the protection of the authenticated software, as well as its differentiation from un-authenticated software, as described in detail below.

Computing Environments

An OS process is the basic unit of work for a computer operating system. When one starts a program, the operating system (OS) loads the program code from disk into memory and starts an OS process to manage the execution of that code in memory. The OS manages multiple OS processes along with other system resources. The OS shares some resources among OS processes but also protects one OS process from another by providing exclusive access of each OS process to specific resources.

Microsoft “dot.Net” code consists of MSIL (Microsoft Intermediate Language) embedded in a PE (Portable Executable) format. When a dot.Net PE is loaded from disk to memory, the MSIL compiler is invoked to create the executable binary code in memory. The end result is the same as a traditional PE containing executable binary code that is mapped into memory when it is “loaded”.

Typically, each OS process gets its own set of memory pages, although some pages can be shared. Processors have the capability to enforce exclusionary page permissions per OS process to protect one OS process from another and to protect pages used by the OS from the various processes. Many of today's operating systems allow page permissions to be too easily changed or have designs that prevent the permissions from being set properly in the first place. One goal of the current invention is to repair this problem.

In typical information appliances, an OS schedules the execution of the various processes and coordinates communication among the processes. Certain processes, sometimes referred to as services, provide common functions needed by the various user-initiated processes. The services are usually started by the OS. Some programs, such as the Microsoft web server IIS, actually consist of more than one OS process, often communicating with one or more services.

Areas to Protect

The two main areas of a computer system where software is found are the disk, which provides permanent storage and the runtime components including primarily memory and the CPU, the central processing unit. The CPU executes instructions located in the memory and reads data from memory or writes data to memory. The CPU also executes code instructions that read and write between the memory and the disk or read and write between the memory and other external devices such as printers, LCD displays and network connections.

Actually modern programs operate with what is termed virtual memory, which provides a consistent and complete range of memory addresses. Combined hardware and software systems provide an automatic mapping from virtual to real memory.

Complete security protection must include mechanisms to secure disks as well as code and data while it is in memory. Further, there must be mechanisms to protect communication.

According to specific embodiments of the invention, the invention establishes a protected area of an information system environment referred to herein as a Secure Code Region. Specifically, those regions of disk and memory where authenticated code is placed are termed the Secure Code Region or SCR.

According to specific embodiments of the invention, a Secure Code Region, or SCR, includes a collection of system resources that are isolated from other system resources outside the SCR, primarily to protect the authenticated code herein.

Software, data and disk storage within an SCR are isolated from the usual security problems and attacks that plague computer systems.

Code in Memory

Protecting code in memory has two goals. One is protecting the code intentionally placed in the SCR from tampering. The other is preventing any other code from running inside an SCR. These goals are accomplished by managing the access permissions on the virtual memory pages. If execution page permissions are not available on a system, then the permissions will be simulated by modifying the OS, primarily the page fault handler.

Data in Memory

An SCR protects its internal data from outside access, including access via debuggers. The SCR blocks debugging to its internal processes either by controlling debug permissions or by blocking the STOP signal used to start debugging. The STOP signal can be controlled by the SCR by means of either signal permissions or directly by modifying the OS internally to allow the SCR to control the STOP signal.

Code and Data on Disk

Each SCR has its own disk area, not visible from outside. An SCR controls visibility either by setting access permissions or by modifying the OS software that manages the physical sectors on the disk to take over visibility control from the OS.

Communication Among SCRs

The System can set up secure channels among the SCRs to block out hostile communications from unknown sources. This can be done by using the common practice of hooking into the TCP-IP stack and applying various standard encoding schemes, possibly including SSL.

File shares are also a major source of outside access, where a local networked application, such as Samba, accesses the local file system. File share access can be controlled by hooking the file access function calls within the local file share application.

Making Code Changes

Dynamic runtime changes to code are typically done to binary code just before execution, where access is gained using standard techniques. Within a computer system there is also higher-level code such as MSIL (Microsoft Intermediate Language), Java Bytecodes, and various script languages, including JavaScript, Perl and Visual Basic. Changes can also be made directly in these abstract codes.

Access points for changes can be identified based on the code processors which are compilers or script engines which interpret the script codes. MSIL can be accessed just before it is compiled down to binary, in which case the resulting binary can be processed also. Java Bytecodes can be accessed just before interpretation or compilation, since it can be interpreted or compiled depending on circumstances. Pure scripts, such as Perl, are generally not compiled and are accessed just before the script engine starts up.

Therefore the SCR system must locate and hook into various interpreters and compilers used during applications, depending on the completeness of the security solution desired.

Instead of, or in addition to, code changes, some language systems allow various security permissions or policies to be set. Java and dot.Net both provide such security policy systems. Often these systems are too complex to be used to their full advantage by programmers, whereas automated control, related to SCR protection, can likely put them to better use.

Typical Configurations

Given a distributed application consisting of web server, business logic and database components, each deployed on separate machines, typically one would place each component in an SCR in their respective machines with connections among these SCRs corresponding to the original communications among the components. This configuration protects the whole distributed application.

IP Protection

Although the Secure CR system is designed primarily for Enterprise systems and networks, it also has applications for protecting electronic intellectual property (IP), including software itself and various forms of media.

The best form of protection for software is encryption. However, software needs to be decrypted to be executed, leaving it in jeopardy. A Secure CR, however, provides a safe region where code can be decrypted and run, keeping the software safe from both tampering and reverse engineering.

Binary codes provide some form of protection merely due to their complexity. Higher level code, such as MSIL or Java, provide significantly less protection since they are so accessible. Encryption combined with execution or use within an SCR provides very strong protection against reverse engineering for such codes.

Media can be well protected by using standard encryption to protect the player, as just described, as well as protecting the content. Similarly, the player and the content can be decrypted inside the Secure CR and then the player can run safely using the decrypted content without exposing key IP or algorithms to hostile inspection or theft.

### BRIEF DESCRIPTION OF THE DRAWINGS

FIG. 1 provides a high-level system overview according to specific embodiments of the invention.

FIG. 2 illustrates setting up the SCR System installation according to specific embodiments of the invention.

FIG. 3 illustrates setting up the SCR System configuration according to specific embodiments of the invention.

FIG. 4 illustrates processing an application as part of the SCR System configuration according to specific embodiments of the invention.

FIG. 5 illustrates runtime processing initiated when an executable or DLL is loaded according to specific embodiments of the invention.

FIG. 6 illustrates runtime processing initiated when input program text is ready just before processing according to specific embodiments of the invention.

### DETAILED DESCRIPTION OF SPECIFIC EMBODIMENTS

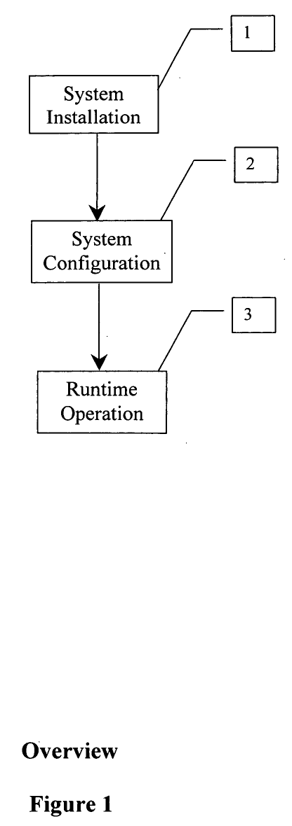

Please refer to FIG. 1 which provides an overview of deployment.

First in (1), the SCR System is installed. This can be done on a single machine or on multiple machines coordinated by a console display. Then in (2) the System is configured by setting up various interconnected Secure CRs on various machines and placing certain applications within the Secure CRs. Finally in (3), as an application starts within a Secure CR, the CR takes control of the OS process and its components in order to protect it.

System Installation

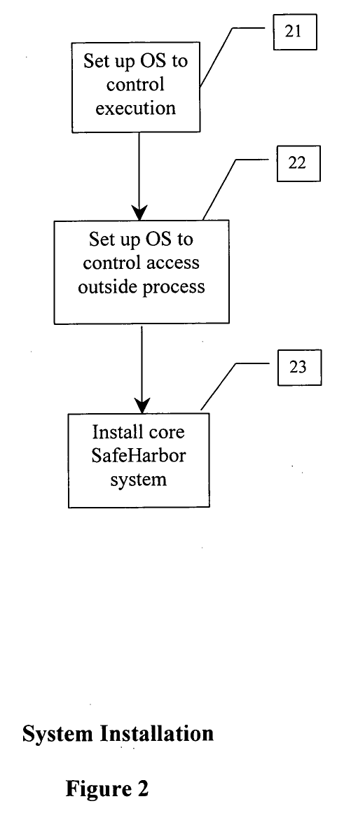

Please refer to FIG. 2 which provides more detail on SCR System installation. In (21) changes are made to the OS internally to control execution within the Secure CR. This is not necessary in newer systems, just becoming available, that support page-level execution permission control in both the hardware and the OS. Otherwise, the execution permissions need to be simulated, primarily by making a small change to the OS virtual addressing page fault handler. This change only needs to be made on Intel machines. Solaris and Sparc have supported this feature for years.

When the OS does not support execute page permissions, that needs to be simulated as well. There are a number of ways to represent page permissions inside the OS. One simple one uses code address ranges. The goal of the SCR System, in this case, is to prevent the instruction TLB cache, ITLB, from getting “contaminated” with data or unauthorized code.

In Intel systems later than Pentium Pro, handling of page faults is done completely in software. Intel machines rely on two caches to handle the mapping of virtual addresses to physical addresses, the ITLB, Instruction Translation Lookaside Buffer for code, DTLB for data. When a virtual address is used that does not have a translation in its corresponding TLB, the hardware accesses the page tables in memory. If the accessed page is resident in memory, the hardware simply reads the translation information into the TLB. Otherwise, the hardware initiates a page fault which activates the page fault handler. The page fault handler then reads in the required page, places the proper address translation into the page tables in memory, and initiates a retry of the faulting memory reference.

In order to detect the execution of unauthorized code, the SCR System modifies the page fault handling process and the page tables in memory in order to initiate a software test when the processor reads the page tables in memory corresponding to non-authorized code. This is done by forcing a page fault for access to such pages by means of manipulating the in-memory page tables, such as by turning off the present-flag. The page fault handler is then activated and checks the validity of the access. If the access is valid, the page fault handler temporarily turns on the present-flag and does a read in order to load the ITLB, after which the present-flag is turned back off. This process is well known to those versed in the art.

In (22), the SCR System makes further changes to the OS internally to control outside access to an OS process from another, such as when debugging might occur. Windows has ways to control debugging permission which could be used, as an option. Otherwise, it would be necessary to block the use of a “STOP” signal to halt a OS process before accessing its internal information. Again these issues are well understood by those versed in the art.

Further, if it is desired to have a strong version of file protection, corresponding to the alternative in (46), the OS is changed to map disk sectors differently so that processes inside an SCR can see a file normally, while outside processes cannot see the file at all. There are different ways to accomplish this well known in the art.

File encryption could also be used here, but it has disadvantages in case keys are lost.

In (23) the SCR System does a normal install of user interface components as well as core management functions involved in assigning an OS process to an SCR and general system management.

System Configuration

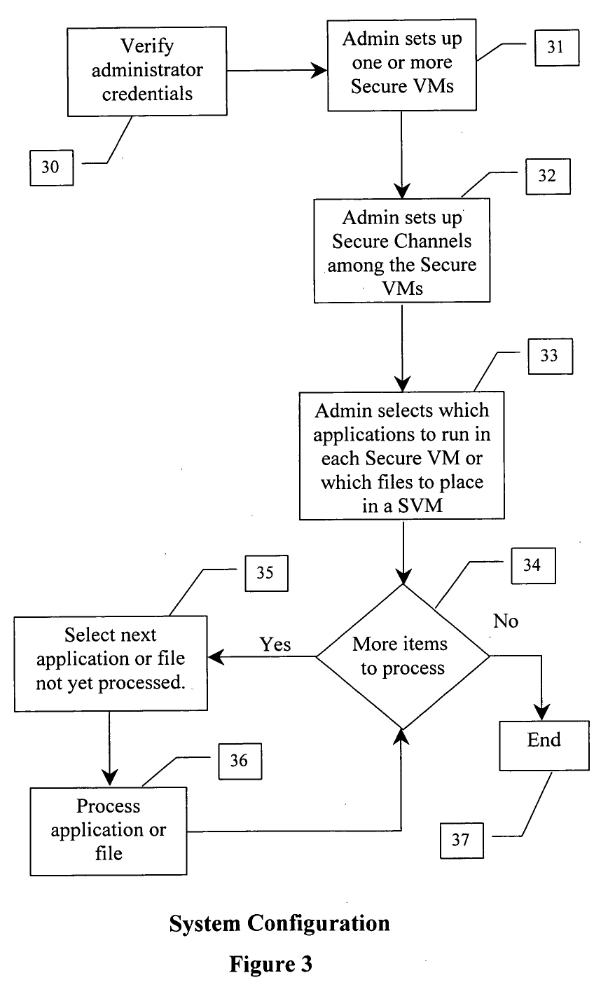

Please refer to FIG. 3 to describe SCR System Configuration. Note that administrator is often abbreviated to admin. This procedure is carried out via an SCR Console that has a global view or via individual machine user interfaces. Later changes or additions are carried out using the same basic procedure as the initial setup where the console or user interface shows the currently selected configuration.

An update as the result of a reinstall or upgrade can be done via these procedures and the console or UI. Such updates can also be integrated in client procedure via specified scripts and APIs in order to provide automation.

In (30) the SCR System verifies the identity of the administrator doing the configuration. This verification can be a simple password or other technique known in the art. Optionally, for additional security, the SCR System will keep a separate list of client approved administrators and require that this administrator be on the list.

In (31) the admin selects which machines to run SCRs, how many SCRs on each and optional naming of each SCR.

In (32) the admin specifies one or more Secure Channel connections among the specified SCRs, or alternatively, approves automatically selected connections chosen by the system.

To implement Secure Channels the System inserts functions into the TCP/IP stack for monitoring and/or management. This is a technique well known in the art.

Network connectivity is also accomplished by file shares and these are set up for control along with the Secure Channels. This may be accomplished by modifying the file share applications, such as Samba, to hook the file access function calls. Such hooking allows the monitoring of file accesses to ensure they match the SCR setups and the allowed access channels. This is a technique well known in the art.

In (33) the admin selects which applications to run in each Secure CR. There are many standard user interface methods to accomplish this. In addition, the user can select certain file to be placed in particular SCRs. The result is a list of top-level applications and files.

In (34) the System determines whether this list is not empty or all its entries have not yet been processed. If there are more application entries to process, the System proceeds to (35). Otherwise, this procedure terminates at (37).

In (35) the System selects one unprocessed application and proceeds to (36).

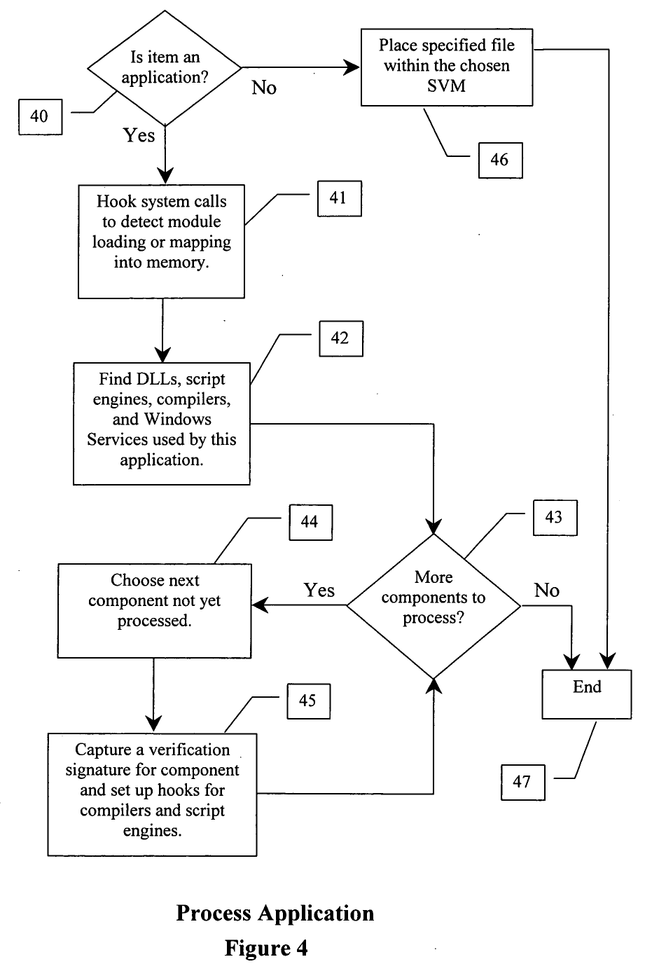

In (36) the System processes the selected application, following FIG. 4, and then proceeds to (34) to continue until all selected applications have been processed.

Processing Applications

Please refer now to FIG. 4.

In (40) determine if the selected item is an application and if so, proceed to (41), otherwise to (46).

In (41) the system sets up a means, well known in the art, to detect the use of the LoadLibrary to load or map into memory a new DLL. When hooking the System Dispatch Table, SDT, LoadLibrary is not available directly, but it maps into NtMapViewOfSection, which is used instead. In addition, the NtCreateSection is used to access file names and paths related to NtMapViewOfSection.

Relative to (42), note that the Microsoft PE executable format provides for import and export tables that allow determination of which functions and which DLLs can be called from a particular executable. In (42) the System follows these links recursively to determine which DLLs can be called from the initial application executable. Further code analysis on these DLLs, and the main executable, allows the System to further determine which Windows Services can be used as well as which compilers or script engines can be invoked. This procedure yields a list of executable components which are then processed in sequence.

In (43) determine if all components on the list have been processed. If there are no more to process, proceed to the end at (47). Otherwise, proceed to (44).

In (44) the next component not yet processed is chosen and the System proceeds to (45).

In (45) scan the selected component and capture a digital signature for it. If the component is a script engine, also known as interpreter, or a compiler, set up an entry point hook that will call into the SCR System right when such a component is to be activated. Such call hooking is well known in the art.

Alternatively, the digital signature is not needed if the file in question is placed in an SCR where it cannot be tampered with since it is not visible outside its containing SCR.

Next the System proceeds to (43).

In (46) Place specified file within the chosen SCR. This is done by setting OS access permissions so that the file appears to only be accessible within the SCR. Alternatively, as set up in (22) above, core OS changes are used to place the file within the SCR so it is only visible there.

Runtime Processing

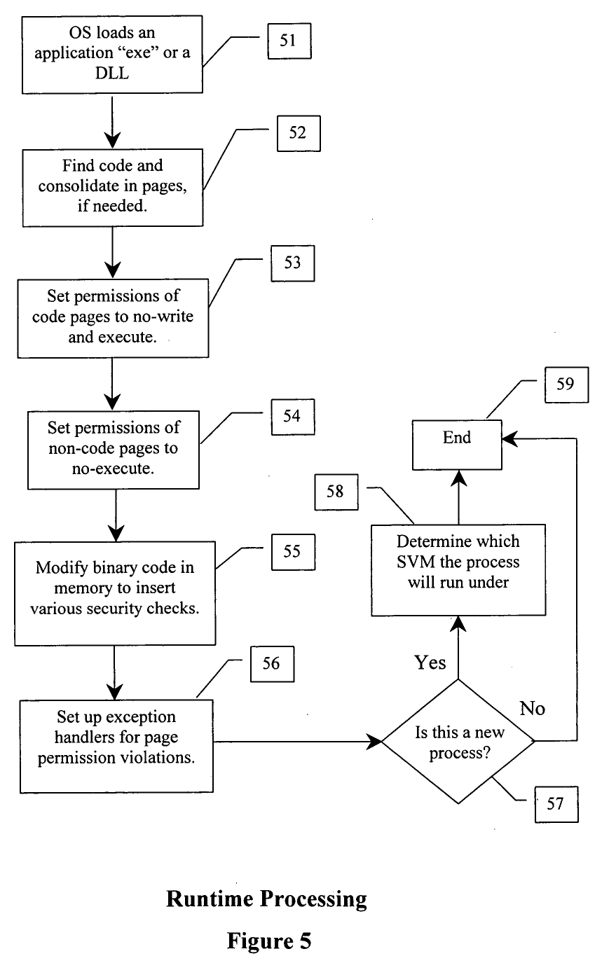

Please refer to FIG. 5.

In (51) the process is begun by intervening when an application has been loaded into memory but before the application begins to execute. In the case of dot.Net code, the MSIL in the PE file is compiled into memory before the code is ready to execute. New code can also arise similarly when a new DLL is loaded via the “LoadLibrary” function. In this case the LoadLibrary or related functions have been “hooked” to provide a control transfer to this SCR component to handle the new code. After loading, Windows provides pointers and functions to find every necessary program component in memory.

In (52) the SCR System checks over all code section to insure they are on pages separate from any data. The SCR System moves the code sections as needed so they are on separate pages, in the process fixing any references to or from other code sections. The pages containing code sections are termed “code pages”. The other pages are termed “data pages”.

In (53) the SCR System sets the permissions of code pages to no-write and execute. The write protection on the code pages prevents them from being tampered with. Since page permissions can be changed by an OS function, the System can add checks to such calls to prevent code pages from being changed during application execution.

In (54) the SCR System sets the permissions of data pages to no-execute, leaving read or write permissions as before. Since only code pages have execution permission, flow of control is prevented from leaving the explicitly allowed code within the SCR. Attempting to execute data results in an exception leading to the activation of an SCR exception handler. Most current attacks result from the execution of data and this cannot happen within an SCR.

In (55) the SCR System modifies the binary code in the code pages to insert checks and change as needed to implement SCR internal security policy. Such code changes for security policy are well known in the art.

In (56) the SCR System sets up exception handlers for page permission violations.

In (57) the SCR System checks if this is a new OS process and if not, ends at (59). Otherwise, in (58) it determines which SCR the new OS process will run under and sets it up appropriately. After that, the System proceeds to the end at (59).

Handling Scripts

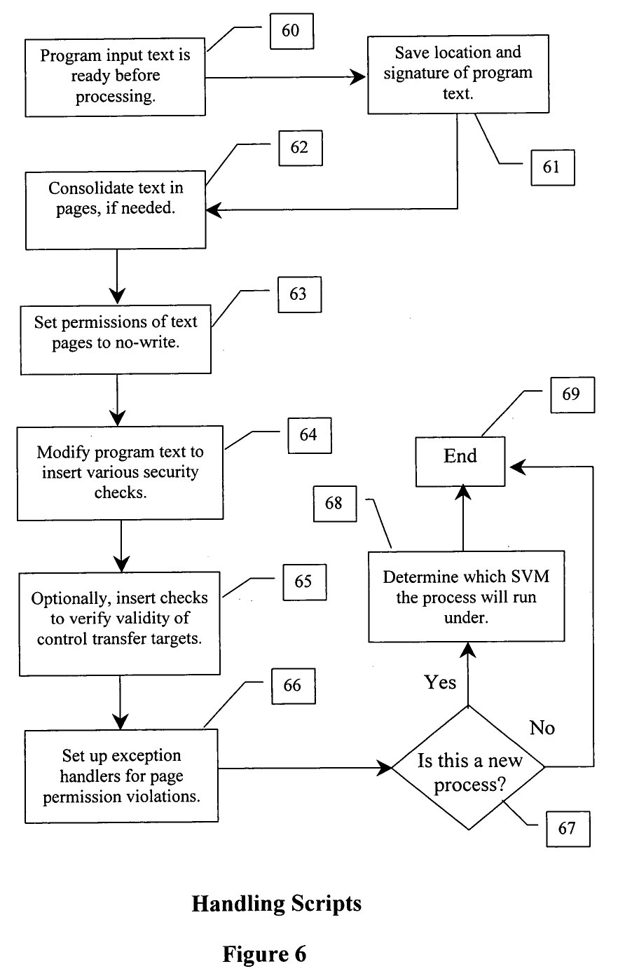

Please refer to FIG. 6.

The system has previously modified code to capture application calls to compilers or script engines. Examples of input to these include MSIL, Bytecodes and Perl, which are an abstract form of code. Bytecodes can be interpreted or, usually selectively, compiled. MSIL (Microsoft Intermediate Language) is compiled. In the case of Java or Microsoft dot.Net there are systems to control access permissions. The permissions can be used instead of or in conjunction with the security approach of checking transfer targets below.

In (60) the program input text is available just before it is to be compiled or interpreted.

In (61) the SCR System saves the location and signature of the input program text.

In (62) the SCR System consolidates the text onto pages if it is in memory.

Then in (63) the System protects the input text by changing page permissions if the text is in memory or by changing file access permissions if the text is in a file.

In (64) the SCR System modifies the input text abstract code to insert checks and change as needed to implement SCR internal security policy.

In (65) the SCR System, optionally, inserts checks to verify validity of control transfer targets. New unknown targets are either tracked closely and audited or blocked by inserted code, depending on SCR System settings and internal policy.

In (66) the SCR System sets up exception handlers for script code access permission violations.

In (67) the SCR System checks if this is a new OS process and if not, ends at (69). Otherwise, in (68) the System determines which SCR the new OS process will run under and sets it up appropriately. After that, (68) proceeds to the end at (69).

What is claimed:

1. A method for protecting a data processor from unauthorized software, comprising:
a) gathering identification and authentication information for known software;
b) storing the said identification information in a database along with its associated said authentication information for said software;
c) validating said software in a data processor by looking up and checking its authentication information in the said database as the said software is moved from disk to memory within the said data processor, while blocking said movement in the case of unauthenticated software or software component;
d) tracking the locations in said memory of said authenticated software as it is moved into said memory;
e) protecting the said validated software in said memory from being modified;
f) validating that control transfers from the said validated software in said memory remain within the said locations;
whereby only authorized code is allowed to run in said data processor and unauthorized code is blocked from running and whereby a complete chain of validity is established starting with discovery and identification of each said software component and ending with controlling the execution in memory of said component.

2. A method according to claim 1 further comprising:
a) allowing unauthenticated software to move into memory;
b) blocking control transfers between memory containing code from authorized software and memory containing code from unauthorized software;
whereby allowing unauthorized code to run, but preventing it from interfering with authorized code.

3. A method according to claim 1 wherein a) further comprises:
a) using hash signatures for authentication, including but not limited to MD5 and SHA-1;
b) gathering the said signatures from a known source or computing said signatures from code components authenticated by other means.

4. A method according to claim 1 wherein a) further comprises:
a) identifying all the components comprising said software;
b) gathering the authentication information for each said component;

5. A method according to claim 1 wherein e) further comprises:
a) finding the virtual memory pages containing the said validated software;
b) setting the permissions to read-only on those said virtual memory pages.

6. A method according to claim 1 wherein a) further comprises:
a) discovering the software already installed on a data processor;
b) automatically identifying some of that said software and authenticating it;
c) enlisting the aid of a system administrator to identify some of the said software that was not identified automatically in step b) and authenticating it.

7. A method according to claim 1 wherein f) further comprises:
a) finding the virtual memory pages containing the said validated software;
b) setting the permissions on those said virtual memory pages to executable.
c) setting the permissions on the other virtual memory pages to no-execute;
whereby data processors are protected from executing foreign software arising from worm attacks.

8. A method according to claim 1 wherein c) further comprises:
a) hooking the internal OS call that maps software on disk to memory pages;
b) providing a hook function for the said OS call that authenticates the said software being moved.

9. A method according to claim 1 wherein f) further comprises:
a) finding the virtual memory pages containing the said validated software;
b) hooking or modifying the existing page fault handler to validate said control transfers via manipulating page table entries to manage TLB content and so keep data entries from getting into the instruction side of the TLB;
whereby data processors without hardware supported execute permission capabilities can have the same protection as those without.

10. A method according to claim 1 wherein f) further comprises:
a) identifying a plurality of valid exceptional conditions when there is a control transfer to code in memory that is not authenticated;
b) allowing said transfer to proceed when said conditions are true;
whereby exceptions are provided for using alternate means to allow code to execute, including, but not limited to, where valid dynamically generated code is created by authenticated code.

11. An apparatus for modifying the software on a data processor to put it into a protected form, comprising:
a) a means of gathering identification and authentication information for known software;
b) a means of storing the said identification information in a database along with its associated said authentication information for said software;
c) a means of validating said software in a data processor by looking up and checking its authentication information in the said database as the said software is moved from disk to memory within the said data processor, while blocking said movement in the case of unauthenticated software or software component;
d) a means of tracking the locations in said memory of said authenticated software as it is moved into said memory;
e) a means of protecting the said validated software in said memory from being modified;
f) a means of validating that control transfers from the said validated software in said memory remain within the said locations;
whereby only authorized code is allowed to run in said data processor, while unauthorized code is blocked from running.

12. An apparatus according to claim 11 further comprising:
a) a means of allowing unauthenticated software to move into memory;
b) a means of blocking control transfers between memory containing code from authorized software and memory containing code from unauthorized software;
whereby allowing unauthorized code to run, but preventing it from interfering with authorized code.

13. An apparatus according to claim 11 wherein a) further comprises:
a) a means of using hash signatures for authentication, including but not limited to MD5 and SHA-1;
b) a means of gathering the said signatures from a known source or computing said signatures from code components authenticated by other means.

14. An apparatus according to claim 11 wherein a) further comprises:
a) a means of identifying all the components comprising said software;
b) a means of gathering the authentication information for each said component;

15. An apparatus according to claim 11 wherein e) further comprises:
a) a means of finding the virtual memory pages containing the said validated software;
b) a means of setting the permissions to read-only on those said virtual memory pages.

16. An apparatus according to claim 11 wherein a) further comprises:
a) a means of discovering the software already installed on a data processor;
b) a means of automatically identifying some of that said software and authenticating it;
c) a means of enlisting the aid of a system administrator to identify some of the said software that was not identified automatically in step b) and authenticating it.

17. An apparatus according to claim 11 wherein f) further comprises:
a) a means of finding the virtual memory pages containing the said validated software;
b) a means of setting the permissions on those said virtual memory pages to executable.
c) a means of setting the permissions on the other virtual memory pages to no-execute;
whereby data processors are protected from executing foreign software arising from worm attacks.

18. An apparatus according to claim 11 wherein c) further comprises:
a) a means of hooking the internal OS call that maps software on disk to memory pages;
b) a means of providing a hook function for the said OS call that authenticates the said software being moved.

19. An apparatus according to claim 11 wherein f) further comprises:
a) a means of finding the virtual memory pages containing the said validated software;
b) a means of hooking or modifying the existing page fault handler to validate said control transfers via manipulating page table entries to manage TLB content and so keep data entries from getting into the instruction side of the TLB;
whereby data processors without hardware supported execute permission capabilities can have the same protection as those without.

20. An apparatus according to claim 11 wherein f) further comprises:
a) a means of identifying a plurality of valid exceptional conditions when there is a control transfer to code in memory that is not authenticated;
b) a means of allowing said transfer to proceed when said conditions are true;
whereby exceptions are provided for using alternate means to allow code to execute, including, but not limited to, where valid dynamically generated code is created by authenticated code.
